(19) United States
(12) Patent Application Publication
(10) Pub. No.: US 2025/0245487 A1
(43) Pub. Date: Jul. 31, 2025

(54) EXECUTION-BASED FEEDBACK-ENHANCED LARGE LANGUAGE MODEL FOR TEST GENERATION

(71) Applicant: Oracle International Corporation, Redwood Shores, CA (US)

(72) Inventors: Damien Hilloulin, Zurich (CH); Jonas Schweizer, Schlieren (CH); Clemence Lanfranchi, Zurich (CH)

(21) Appl. No.: 18/429,263

(22) Filed: Jan. 31, 2024

(51) Int. Cl. G06N 3/0455; G06F 11/36; G06N 3/0895

(52) U.S. Cl. CPC G06N 3/0455; G06F 11/368; G06F 11/3688; G06N 3/0895

(57) ABSTRACT

Techniques for automatically generating tests using a large language model (LLM) are provided. In one technique, a set of positive training samples for training a first LLM is stored. Based on that set, a set of correction training samples is generated, each sample including an error from processing a faulty test of particular code. A second LLM is trained based on those samples. A first test, of code, that was generated by the first LLM is received. A first result of processing the first test is generated. In response to determining that the first result indicates an error in processing the first test, a first correction prompt is generated based on the first result. The first correction prompt is input into the second LLM that outputs a second test that is a corrected version of the first test. A second result of processing the second test is generated.

### TECHNICAL FIELD

The present disclosure relates generally to language models and, more specifically, to enhancing language models to generate valid code tests.

### BACKGROUND

Testing code is a fundamental practice when developing software. Testing code ensures that all modules in a software application work as intended. Unit tests in particular check if small, isolated units of code function correctly. Unit tests are critical in identifying and fixing inconsistencies that may arise from updates and refactoring. Despite being so important, writing unit tests is often neglected by software developers because writing unit tests is cumbersome and slows down the process of developing a software application.

Large language models (LLMs) have shown remarkable capacities in code understanding and code generation. However, writing quality unit tests requires an in-depth understanding of the code as well as good mathematical reasoning, which is often lacking in LLMs. Current LLM approaches for generating tests suffer from multiple significant drawbacks, including hallucination, correctness, and uncontrolled generation. Regarding hallucination, current LLM approaches often fail to generate the correct values. LLMs use probabilities and a previous sequence of characters to determine what to include next. Thus, LLMs do not actually compute “5+3”, but rather “guess” at what the next character(s) will be, which may be “=13” instead of “=8.” Regarding correctness, current LLM approaches unintentionally introduce type errors in generated code. For example, an LLM may incorrectly infer parameters of a function, such as naming an input parameter ‘b’ instead of ‘a.’ Regarding uncontrolled generation, LLMs tend to not stop where they should. For example, an LLM might generate multiple tests when only one test was requested.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for generating unit tests, in an embodiment;

FIG. 2 is a block diagram that depicts a test and correction example, in an embodiment;

FIG. 3 is a flow diagram that depicts an example process for generating unit tests, in an embodiment;

FIG. 4 is a block diagram that illustrates a computer system upon which an embodiment of the invention may be implemented;

FIG. 5 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for automating the generation of unit tests using leveraging large language models (LLMs) are provided. A framework is provided for fine-tuning and inference with any LLM, which increases the quality of the generated tests. The framework comprises (1) a self-correction feedback loop that allows a model to utilize error feedback signals to guide the model towards producing more correct unit tests and (2) a synthetic data generation technique that allows a model to be trained to better correct its mistakes. Thus, embodiments improve computer-related technology involving the automatic generation of unit tests using LLMs. Specifically, automatically-generated unit tests are automatically verified and corrected. This substantially improves the generated code quality as it allows the generation of syntactically and functionally correct results. Also, by training on a synthetically-generated dataset of test failures cases, the model learns how to fix mistakes and improve faulty tests. The feedback loop counters the lack of mathematical reasoning of LLMs.

### System Overview

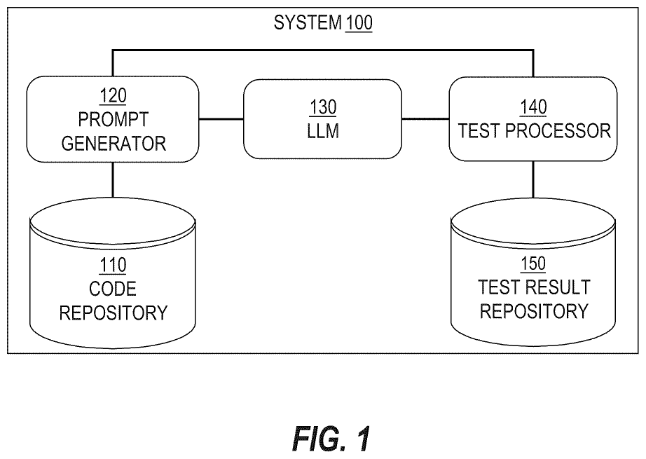

FIG. 1 is a block diagram that depicts an example test generation system 100 for generating unit tests, in an embodiment. System 100 comprises a code repository 110, a prompt generator 120, a large language model (LLM) 130, a test processor 140, and a test result repository 150. Code repository 110 comprises one or more sets of (e.g., source) code for one or more software programs. Each set of code may comprise multiple files, each corresponding to a different function or set of functions, each of which may be invoked by the corresponding software program when executed.

Prompt generator 120 generates a prompt to be sent to LLM 130. Prompt generator 120 may be invoked or called by another process or component, such as one that is remote relative to system 100. For example, a client that is remote relative to system 100 sends a test generation request over a computer network (e.g., the Internet or a local area network (LAN)) to prompt generator 120. The test generation request may include a code identifier that uniquely identifies a piece of code (e.g., using a file name and/or path name) in code repository 110. The test generation request may also include instructions to include in a prompt for LLM 130. In response to a test generation request, prompt generator 120 retrieves the piece of code from code repository 110 (based on the code identifier) and generates a prompt that includes the piece of code. The prompt may also include any instructions from the test generation request and/or may include different instructions. Such different instructions may be based on the type of code, the language in which the piece of code is written (e.g., Java, Python), etc.

LLM 130 accepts, as input, a prompt from prompt generator 120 and, in response, generates or outputs a test, such as a unit test, for the piece of code that is included in the prompt. Generally, an LLM is a type of language model notable for its ability to achieve general-purpose language understanding and generation. LLMs acquire these abilities by using large amounts of data to learn millions or billions of parameters during training and consuming large computational resources during their training and operation. LLMs are artificial neural networks (mainly transformers) and are trained using self-supervised learning and/or semi-supervised learning.

Test processor 140 processes the test that LLM 130 generates. Processing the test comprises executing the piece of code based on the test parameters. Test parameters may include one or more inputs to a function reflected in the piece of code and one or more expected outputs to be produced by the function. Test processor 140 (or another component of system 100) determines whether the actual output(s) match the expected output(s). If so, then the test passes; otherwise, the test fails.

A test may fail for one or more reasons. For example, the function may expect a different type or number of inputs, which causes the function to raise an exception. As another example, the actual output may not match the expected output, which is an assertion error.

If a test passes (i.e., there are no errors), then test processor 140 stores the result of the test (and, optionally, the test) in test result repository 150. If the test fails, then test processor 140 (or another component of system 100, not depicted) may also store the result in test result repository 150.

In response to detecting a failed test, test processor 140 (or another component of system 100) sends at least a description of the error to prompt generator 120 or to another prompt generator that may be configured differently than prompt generator 120. The following description is an embodiment that involves only a single prompt generator, but all embodiments are not so limited. For example, one prompt generator may be configured to generate initial prompts for LLM 130, whereas another prompt generator may be configured to generate correction prompts for LLM 130 or for another LLM that is trained specifically to correct tests generated by LLM 130.

Test processor 140 (or another component of system 100) may also send, to prompt generator 120, the test and/or the code that failed the test. Alternatively, test processor 140 sends a test identifier and/or a code identifier to prompt generator 120, which uses the one or more identifiers to lookup the corresponding test and/or code, which may be used as input to LLM 130.

Prompt generator 120 accepts the error as input and generates another prompt for LLM 130 (or another LLM). Thus, the other prompt includes (1) the error and may also include (a) the test that resulted in an error and (b) the code for which the test is being generated.

### Example Error Feedback

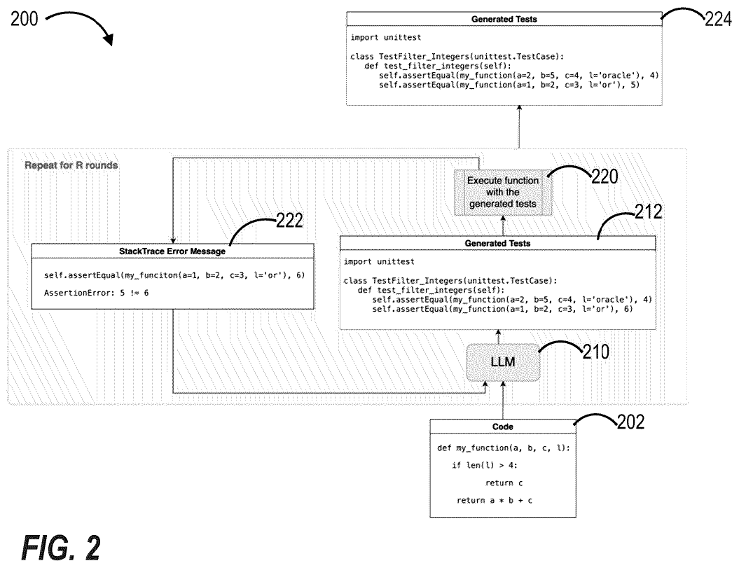

FIG. 2 is a block diagram that depicts an example error feedback loop 200 in a test generation process, in an embodiment. Error feedback loop 200 comprises LLM 210 (which may correspond to LLM 130 in FIG. 1), test processor 220 (which may correspond to test processor 140 in FIG. 1), and inputs and outputs of each. Input to LLM 210 comprises code 202, which comprises a function that is to be tested. Code 202 is human-readable code that may be in any programming language, such as Java, C++, or Python. In response to receiving code 202, LLM 210 generates test 212 as output.

Test 212 may comprise a single assertion or multiple assertions. Each assertion references a function in code 202. If test 212 includes multiple assertions, then each assertion in test 212 may include a different set of input compared to other assertions in test 212. Test 212 is then input to test processor 220.

Test processor 220 executes code 202 based on test 112. Executing code 202 may involve compiling code 202 to generate compiled code, or object code, examples of which include machine code and byte code, which is ultimately executed when running test 212. Running test 212 involves calling or executing code 202 for each assertion in test 212. Thus, if test 212 includes multiple assertions, then each executing code 202 (or calling or invocation of a function in code 202) involves a different set of input.

The output of test processor 220 executing code 202 (or a compiled version thereof) when running test 212 is either a negative result 222 or a positive result 224. Positive result 224 indicates that no errors were detected while running test 212. Negative result 222 indicates that at least one error was detected while running test 212. Error types include errors in execution (e.g., the wrong input data types or the wrong number of input parameters) or errors in expected output.

If the output of test processor 220 is positive result 224, then test 212 is a valid test. Otherwise, negative result 222 is the output and includes one or more error messages. In case of negative result 222, the one or more error messages, code 202, and test 212 that failed are combined (e.g., by prompt generator 120) and input to LLM 210 (or to another LLM, not depicted). Prompt generator 120 may order and/or format these three pieces of data in a particular manner. With the combined data, LLM 210 (or another LLM) outputs a new test, which test processor 220 executes and the process repeats.

In an embodiment, LLM 210 is invoked a limited number of times for the same instance of code 202. For example, if a generated test is not corrected after five attempts, then LLM 210 is not invoked again for code 202. Data that identifies such a test and/or the corresponding code may be stored (e.g., in test result repository 150) to track which tests and/or code are associated with repeated errors. Repeated errors associated with a test may indicate that the test is bad and not correctable, that code 202 is incorrect, that the output of code 202 is too complex to infer, or that LLM 210 is performing poorly.

In an embodiment, system 100 includes multiple LLMs that are trained and invoked, each LLM corresponding to a different programming language. For example, one LLM is trained to generate and/or correct (e.g., unit) tests written in Java while another LLM is trained to generate and/or correct tests written in Python. Alternatively, a single LLM is trained to generate and/or correct tests written in multiple programming languages.

### Two-Model Implementation

In the example in FIG. 1, LLM 130 generates both (1) the initial test given a test creation prompt and (2) a correction of the initial test based on a test correction prompt.

In another embodiment, a first language model generates unit tests based on test creation prompts while a second (different) language model generates, based on test correction prompts, corrections of errors that result from those unit tests. An advantage of this embodiment is that the second language model may be much smaller than the first language model and, therefore, the time to train the second language model may be much less than the time to train the first language model. Additionally, due to their respective sizes or memory footprints, the latency of the second language model may be much less than the latency of the first language model and the infrastructure needed to serve the second, smaller language model is much smaller and cheaper.

### Error Types

Many different types of errors may result from executing a unit test against code that includes a function under test. Embodiments are not limited to one type or class of error. One type of error is an output type error where the type of output is incorrect. For example, a function returns an integer instead of a string (or another data type).

Another type of error is a function call error where the function being tested is not called with the right parameters. For example, a function may require two input parameters but the test only calls the function with a single parameter. As another example, although a test may call a function with the correct number of parameters, the test calls the function with the parameters in an incorrect order (e.g., an integer before a list instead of a list before an integer). As another example, the data type of an input parameter is incorrect.

Another type of error is an assertion error where the function being tested returns a value that is different than the expected value that LLM 130 originally output, even though the value may be the correct type. For example, the test indicates that a function should return a ‘5’ but the function returns an ‘8.’

Different programming languages may have different types of errors. Embodiments are not limited to errors from one programming language but may include being able to handle error types that are specific to certain programming languages.

### Generating Positive Training Samples

In an embodiment, system 100 includes a positive training sample generator (not depicted) that generates positive training samples that are used to train LLM 130. The positive training sample generator randomly samples inputs in the correct input space, executes the function (for which tests will be generated) with the sampled input parameters to obtain the expected output, and generates the test corresponding to a chosen standard test framework (e.g., Unittest for Python). Therefore, it is presumed that the function will produce the correct output whenever the function is invoked.

In an embodiment, a portion of a positive training sample includes instructions for LLM 130 to generate a unit test. The instructions are referred to as “model instructions.” Model instructions may be high-level instructions, such as “Below is a Python function. Write a test for it.”

Given (optional) model instructions, a function to test, the corresponding input parameter space, and a number of samples to generate, pseudo code for generating positive training samples may be the following:

```
procedure GeneratePositiveSamples(modelInstructions, function,
  inputSpace, nPositiveSamples)
  L ← [ ] //variable L is initially an empty list
  n ← 0 //variable n is an integer that is initialized to 0
  repeat
    n ← n + 1
    inputs ← sampleInputArguments(inputSpace)
    executionOutput, successfulExecution ← function(inputs)
    if successfulExecution == True then
      positiveSample ← formatPositiveSample(codeInstructions,
        function, inputs, executionOutput)
      AddItem(L, positiveSample)
  until n = nPositiveSamples //only repeat if n != nPositiveSamples
  return L
end procedure
```

The function ‘sampleInputArguments’ accepts an input space as input and generates a set of inputs for the function (or code) to be tested. The input space may be a list of one or more input data types and/or a list of one or more ranges of values, from which data types may be inferred. For example, an input space parameter may be “int” indicating that selecting any integer value is valid. As another example, an input space parameter may be “integer 0-1,000,000” indicating that valid values for this input space parameter are integers between 0 and 1,000,000. As another example, an input space parameter may be “string” indicate that selecting any string value is valid.

The set of inputs that function ‘sampleInputArguments’ outputs may be a single input or may be multiple inputs. If the set of inputs comprises multiple inputs, then the resulting positive training sample will have multiple assertions, one for each input, as indicated in the example sample below.

The function ‘function’ is the code function to be test. A result of executing ‘function (inputs)’ (where ‘inputs’ come from the ‘sampleInputArguments’ function) is stored in the variable ‘executionOutput.’ The result is the output of the function ‘function.’ If the function fails (e.g., an error or exception is raised or nothing is returned), then the variable ‘successfulExecution’ may be set to a Boolean value, such as ‘False’; otherwise the ‘successfulExecution’ variable may be set to ‘True.’

In an embodiment, if executing ‘function (inputs)’ results in an error or exception that pertains to input parameter values that are faulty (e.g., not within a proper range of input values), then function ‘sampleInputArguments’ may be executed again to obtain another set of inputs for ‘function (inputs).’

The function ‘formatPositiveSample’ generates a positive training sample by formatting the different inputs (the first column and the second column) into a single test creation prompt for LLM 130. An example of a formatted positive training sample is found in the third column of the following:

| | | |
|---|---|---|
| Python function that | def add(a: int, b: int) −> int: | ### Instruction: |
| computes the sum of 2 | return a + b | Below is a python function. Write a |
| integers | | test for it |
| | | ## Code: |
| | | def add(a: int,b: int) −> int: |
| | | “““Python function that |
| | | computes the sum of two |
| | | integers ””” |
| | | return a + b |
| | | ### Response: |
| | | assert add(a=0, b=0) == 0 |
| | | assert add(a=2, b=2) == 4 |
| | | assert add(a=−4, b=3) == −1 |

In this example, there are three sections of the prompt, or positive training sample: the instruction section (that instructs LLM 130 what to do); the code section that includes the function/code to be tested and, in this example, a description of what the function to be tested does (or is supposed to do), which is found in the second column above; and a response section that includes multiple assertions. In this example, because there are three assertions, the function ‘sampleInputArguments” must have produced three inputs. Descriptions are optional and, if one exists, may be either (a) part of the input code or (b) generated by another language model, for example, as a “preparation step” in order to increase the probability of generating a good test.

### Generating Correction Training Samples

In an embodiment, system 100 includes a correction training sample generator (not depicted) that automatically generates correction training samples based on positive training samples, whether or not the positive training samples were generated automatically or manually. The correction training samples are used to train LLM 130 (or another LLM, in a two-model embodiment) to correct incorrect tests, or tests that resulted in errors. To generate correction training samples, positive training samples may be modified (or mutated) to generate a faulty test. Then the faulty test is executed to collect error or failure information. The error information is later combined with the function and test, which combination serves as feedback information for LLM 130.

Though the mutation operators described herein are generic, mutation operators may differ depending on the programming language or use case. For example, in the context of the Python programming language, the input may be modified or the expected function output may be modified, which will result in an assertion error. Examples of a value modification include replacing an integer value with a different integer value, replacing a string with a different string, and replacing a value of one data type (e.g., integer) to a value of a different data type (e.g., string). As another example, input parameters to a function may be renamed, added, reordered, or removed, which will result in type errors.

Given (optional) model instructions, a function to test, the sampled inputs used for the positive tests, the output obtained from the sampled inputs, the mutation operators, and a number of negative training samples to generate for each positive training sample, example pseudo code for generating correction training samples is the following:

```
procedure GenerateCorrectionSamples(codeInstructions, function,
  testInputs, testOutputs, mutatingOperators, nCorrectionSamples)
  L ← [ ]
  n ← 0
  repeat
    n ← n + 1
    mutatedInputs, mutatedOutputs ← randomlyMutateInputs(testInputs,
      testOutputs, mutatingOperators) mutatedTest ←
      formatTest(functionName, mutatedInputs, mutatedOutputs)
    failureFeedback ← executeFunction(functionName, function,
      mutatedInputs)
    correctedTest ← formatTest(testInputs, testOutputs)
    correctionSample ← formatCorrectionSample(mutatedTest,
      failureFeedback, correctedTest)
    AddItem(L, correctionSample)
  until n = nCorrectionSamples
  return L
end procedure
```

Thus, if nCorrectionSamples is ten, then ten correction training samples are generated, each based on the same testInputs and testOutputs.

In this example procedure, the function ‘randomlyMutateInputs’ applies one or more random mutation operators to modify the test inputs (i.e., the function input arguments) or modify the test outputs (i.e., the expected output from executing the function with the test inputs). Examples of random mutation operators include reordering input parameters, changing the type of an input parameter or of the output of the function, removing an input parameter, and adding an input parameter. If there are multiple random mutation operators from which to select, then this function (to apply one or more random mutation operators) may include an operation to select a subset of the available mutation operators. The selection of the subset may itself be random or operate in a round robin fashion.

The function ‘executeFunction’ calls the function (for which tests are being automatically generated) and passes the mutated inputs (‘mutatedInputs’) as input to that function. Also ‘functionName’ is input to the function ‘executeFunction’ to ensure which function to execute. The code might contain several functions, but only one function is to be tested. For example, code contains f1 and f2, but f1 uses f2 internally; thus, the code for both functions is needed, but a unit test is only needed for f1. Output of the ‘executeFunction’ function is assigned to the ‘failureFeedback’ variable. Due to the mutated inputs, it is presumed that the function will produce an error or will fail in some manner.

The function ‘formatTest’ combines the correct test inputs and outputs, resulting in a ‘correctedTest’ value. This value will become part of the correction training sample that is ultimately produced by this example procedure. This value, when combined with the other data that is part of a correction training sample and used to finetune LLM 130, “teaches” LLM 130 what the result of the test should be like.

Similar to the function ‘formatPositiveSample,’ the function ‘formatCorrectionSample’ generates a correction training sample that comprises an instruction, the code in question, a unit test that resulted in an error, an error or failure that resulted from executing the unit test in light of the code, and a correct response that the model should have generated. The following table includes a single positive training sample (in the left column) and two correction training samples (in the right column) that were automatically generated based on the positive training sample:

| | |
|---|---|
| ### Instruction: | ### Instruction: |
| Below is a python function. Write a test for it | Below is a python function with an |
| ## Code: | associated test. The test is incorrect and |
| def add(a: int,b: int) −> int: | failed. Given the error message, correct the |
| “““Python function that computes the sum of | test assertion |
| two integers ””” | ## Code: |
| return a + b | def add(a: int,b: int) −> int: |
| ### Response: | “““Python function that computes the sum of |
| assert add(a=0,b=0) == 0 | two integers ””” |
| assert add(a=2,b=2) == 4 | return a + b |
| assert add(a=−4,b=3) == −1 | ## Test: |
| | assert add(a=0,b=0) == −1 |
| | assert add(a=2,b=2) == 4 |
| | assert add(a=−4,b=3) == −1 |
| | ## Failure: |
| | assert add(a=0,b=0) == −1 |
| | AssertionError: expected 0, got −1 |
| | ### Response: |
| | assert add(a=0,b=0) == 0 |
| | assert add(a=2,b=2) == 4 |
| | assert add(a=−4,b=3) == −1 |
| | ### Instruction: |
| | Below is a python function with an |
| | associated test. The test is incorrect and |
| | failed. |
| | Given the error message, correct the test |
| | assertion |
| | ## Code: |
| | def add(a: int,b: int) −> int: |
| | “““Python function that computes the sum of |
| | two integers ””” |
| | return a + b |
| | ## Test: |
| | assert add(a=0,c=0) == 0 |
| | assert add(a=2,b=2) == 4 |
| | assert add(a=−4,b=3) == −1 |
| | ## Failure: |
| | assert add(a=0,c=0) == 0 |
| | TypeError: add( ) got unexpected argument ‘c’ |
| | ### Response: |
| | assert add(a=0,b=0) == 0 |
| | assert add(a=2,b=2) == 4 |
| | assert add(a=−4,b=3) == −1 |

Once a dataset of correction training samples {instruction, code function, test, failure, response} is generated, LLM 130 is finetuned with the dataset. Such finetuning allows the model to learn (1) a testing framework so that generated tests have the same formatting and can be evaluated easily and (2) how to fix a mistake based on the stack trace of a failed test. In this way, instead of rewriting a new test, LLM 130 only fixes the incorrect part of a previously generated test. Example finetuning techniques include instruction finetuning, LoRa finetuning, and other finetuning techniques that are suitable for LLMs.

In an embodiment, a diverse set of error types are included in the correction training dataset to make the model as polyvalent as possible. In coding practice, the distribution of error types discovered in developing software is not uniform. Some error types occur much more than others. Thus, embodiments may involve generating more correction training samples for error types that are more common.

### Example Process

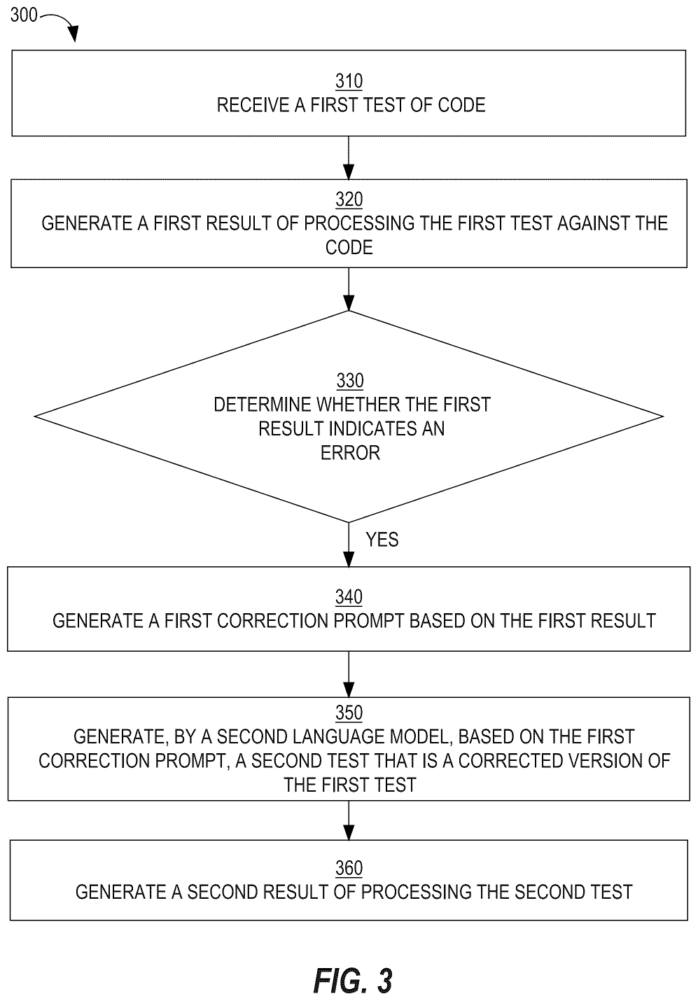

FIG. 3 is a flow diagram that depicts an example process 300 for generating unit tests, in an embodiment. Process 300 may be performed by different components of system 100.

At block 310, a first test of code is received. The first test was generated by a first language model. The first test of code may have been triggered by a test generation request that was sent to a component of system 100 (e.g., prompt generator 120), which generated a test generation prompt in response and sent the test generation prompt to the first language model as input.

At block 320, a first result of processing the first test against the code is generated. Block 320 may be performed by test processor 140. The first test may comprise multiple calls of the code, each call including a different set of inputs. If processing the first test did not result in a failure, such as a type error or exception, then the first test may also involve comparing (1) actual output from calling/executing the code with (2) expected output indicated in the first test. If the comparison results in a “no match,” then this is an assertion error.

At block 330, it is determined whether the first result indicates an error (or failure) in processing the first test against the code. Block 330 may involve test processor 140 analyzing the first result for any text that indicates an error.

At block 340, in response to determining that the first result indicates an error (or failure) in processing the first test against the code, a first correction prompt is generated based on the first result. In some instances, the first language model may generate a test that does not result in any error or failure.

At block 350, a second language model generates, based on the first correction prompt, a second test that is a corrected version of the first test. The second language model may be the same as (or different than) the first language model.

At block 360, a second result of processing the second test is generated. If the second result indicates an error or failure, then process 300 returns to block 340 where a second correction prompt is generated based on the second result and eventually a third test is generated based on the second correction prompt (in a second iteration of block 350). Otherwise, the second test is determined to be a valid test. If process 300 returns to block 340, then a counter may be maintained to determine how many times block 340 has been performed for the code for which the first test was automatically generated. Block 360 may also involve storing the second result (e.g., in test results repository 150), regardless of whether the second result indicated a positive result or a negative result.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

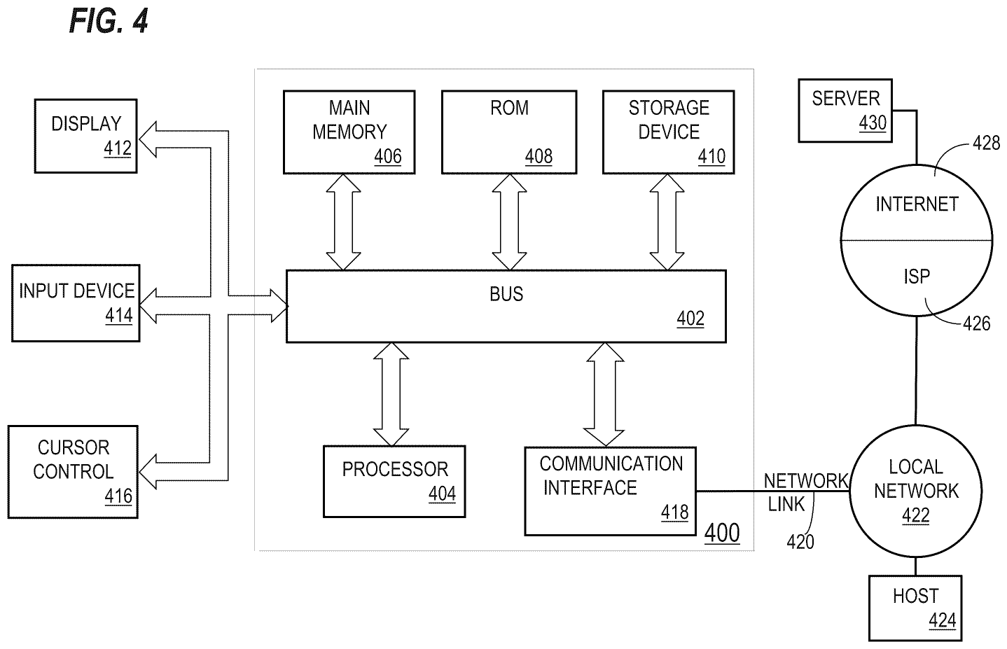

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

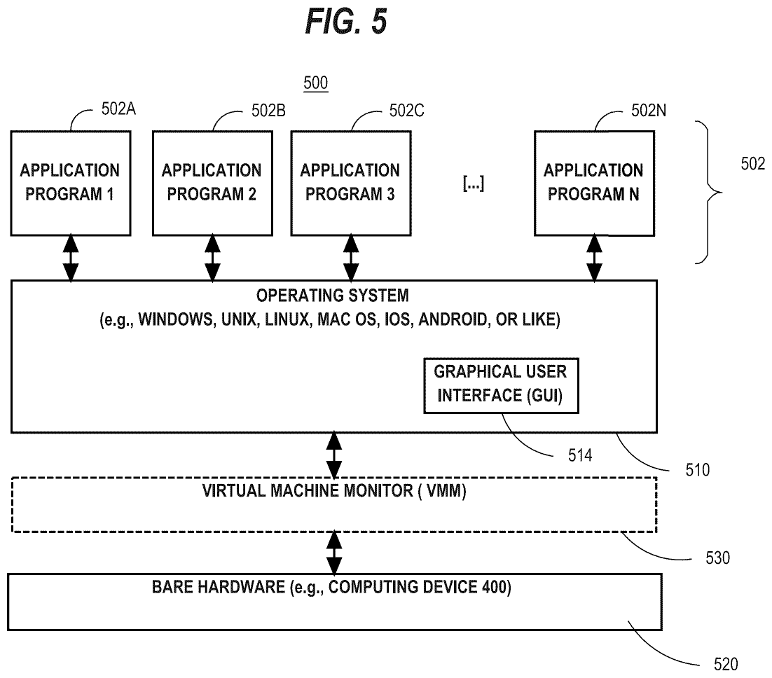

FIG. 5 is a block diagram of a basic software system 500 that may be employed for controlling the operation of computer system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a set of positive training samples for training a first language model;
based on the set of positive training samples, generating a set of correction training samples, wherein each correction training sample in the set includes an error from processing a faulty test of particular code;
training a second language model based on the set of correction training samples;
receiving a first test, of code, that was generated by the first language model;
generating a first result of processing the first test against the code;
in response to determining that the first result indicates an error in processing the first test against the code, generating, based on the first result, a first correction prompt;
inputting the first correction prompt into the second language model that outputs a second test that is a corrected version of the first test;
generating a second result of processing the second test;
wherein the method is performed by one or more computing devices.

2. The method of claim 1, wherein the first language model is the same as the second language model.

3. The method of claim 1, wherein the second prompt includes an indication of the error.

4. The method of claim 1, further comprising:
determining whether the second result indicates an error in processing the second result;
in response to determining that the second result indicates an error in processing the second test against the code, generating, based on the second result, a second correction prompt that is different than the first correction prompt;
inputting the third correction prompt into the second language model that outputs a third test that is a corrected version of the second test.

5. The method of claim 4, further comprising:
determining a number of tests that were processed against the code and that resulted in an error;
in response to determining that the number of tests is equal to a threshold number, determining to not generate any more tests for the code.

6. The method of claim 1, further comprising:
determining whether the second result indicates an error in processing the second result;
in response to determining that the second result does not indicate an error in processing the second test;
storing data that indicates that the second test is a valid test.

7. The method of claim 1, further comprising, prior to receiving the first test:
sampling input data from an input space associated with a function in the code;
calling the function with the input data, wherein calling the function results in output from the function;
generating a positive training sample that comprises the function, the input data, and the output;
adding the positive training sample to the set of positive training samples.

8. The method of claim 1, wherein each correction training sample in the set of correction training samples comprises particular code to be tested, a mutated test that resulted in a particular error, a description of the particular error, and a corrected test that is a modified version of the mutated test.

9. The method of claim 1, wherein generating the set of correction training samples comprises, given a positive training sample, in the set of positive training samples, that includes particular code:
mutating one or more test inputs of a valid test in the positive training sample to generate mutated data;
executing the particular code with the mutated data, which executing results in generation of a particular error;
including, in a correction training sample, the mutated data, the particular error, and the valid test;
finetuning the second language model based on the correction training sample.

10. The method of claim 1, wherein generating the set of correction training samples comprises, given a positive training sample, in the set of positive training samples, that includes particular code:
mutating one or more test outputs of a valid test in the positive training sample to generate a mutated test;
executing the particular code based on the mutated test, which executing results in a failure of the mutated test;
including, in a correction training sample, the mutated test, a description of the failure, and the valid test;
finetuning the second language model based on the correction training sample.

11. A method comprising:
receiving a first test, of code, that was generated by a first language model;
generating a first result of processing the first test against the code;
in response to determining that the first result indicates an error in processing the first test against the code, generating, based on the result, a first correction prompt;
inputting the first correction prompt into a second language model that is different than the first language model and that outputs a second test that is a corrected version of the first test;
generating a second result of processing the second test;
wherein the method is performed by one or more computing devices.

12. One or more non-transitory storage media storing instructions which, when executed by one or more computing devices, cause:
storing a set of positive training samples for training a first language model;
based on the set of positive training samples, generating a set of correction training samples, wherein each correction training sample in the set includes an error from processing a faulty test of particular code;
training a second language model based on the set of correction training samples;
receiving a first test, of code, that was generated by the first language model;
generating a first result of processing the first test against the code;
in response to determining that the first result indicates an error in processing the first test against the code, generating, based on the first result, a first correction prompt;
inputting the first correction prompt into the second language model that outputs a second test that is a corrected version of the first test;
generating a second result of processing the second test.

13. The one or more storage media of claim 12, wherein the first language model is the same as the second language model.

14. The one or more storage media of claim 12, wherein the second prompt includes an indication of the error.

15. The one or more storage media of claim 12, wherein the instructions, when executed by the one or more computing devices, further cause:
determining whether the second result indicates an error in processing the second result;
in response to determining that the second result indicates an error in processing the second test against the code, generating, based on the second result, a second correction prompt that is different than the first correction prompt;
inputting the third correction prompt into the second language model that outputs a third test that is a corrected version of the second test.

16. The one or more storage media of claim 15, wherein the instructions, when executed by the one or more computing devices, further cause:
determining a number of tests that were processed against the code and that resulted in an error;
in response to determining that the number of tests is equal to a threshold number, determining to not generate any more tests for the code.

17. The one or more storage media of claim 12, wherein the instructions, when executed by the one or more computing devices, further cause:
determining whether the second result indicates an error in processing the second result;
in response to determining that the second result does not indicate an error in processing the second test;
storing data that indicates that the second test is a valid test.

18. The one or more storage media of claim 12, wherein the instructions, when executed by the one or more computing devices, further cause, prior to receiving the first test:
sampling input data from an input space associated with a function in the code;
calling the function with the input data, wherein calling the function results in output from the function;
generating a positive training sample that comprises the function, the input data, and the output;
adding the positive training sample to the set of positive training samples.

19. The one or more storage media of claim 12, wherein each correction training sample in the set of correction training samples comprises particular code to be tested, a mutated test that resulted in a particular error, a description of the particular error, and a corrected test that is a modified version of the mutated test.

20. The one or more storage media of claim 12, wherein generating the set of correction training samples comprises, given a positive training sample, in the set of positive training samples, that includes particular code:
mutating one or more test inputs of a valid test in the positive training sample to generate mutated data;
executing the particular code with the mutated data, which executing results in generation of a particular error;
including, in a correction training sample, the mutated data, the particular error, and the valid test;
finetuning the second language model based on the correction training sample.
